(19) United States
(12) Patent Application Publication
(10) Pub. No.: US 2023/0101675 A1
(43) Pub. Date: Mar. 30, 2023

(54) DISCOVERY ENGINE FOR INTERACTIVE VIDEOS

(71) Applicant: JBF Interlude 2009 LTD, Tel Aviv (IL)

(72) Inventors: Jonathan Bloch, Tel Aviv (IL); Tal Zubalsky, Brooklyn, NY (US); Yuval Hofshy, Kfar Saba (IL); Alon Benari, Brooklyn, NY (US)

(21) Appl. No.: 17/484,604

(22) Filed: Sep. 24, 2021

(51) Int. Cl. G06Q 30/06; G06F 16/9035

(52) U.S. Cl. CPC G06Q 30/0621; G06Q 30/0631; G06F 16/9035; G06Q 30/0643

(57) ABSTRACT

A method for providing a discovery engine for filtering a plurality of items. The method includes displaying a first interactive module of a plurality of interactive modules to a user, receiving a first user interaction associated with the first interactive module, filtering the plurality of items based on the first interaction to provide a first group of items, displaying a second interactive module of the plurality of interactive modules to the user, receiving a second user interaction associated with the second interactive module, filtering the first group of items based on the second interaction to provide a second group of items, and displaying a third interactive module of the plurality of interactive modules, the third interactive module being configured to present at least a portion of the second group of items to the user as a recommended group of items.

### TECHNICAL FIELD

The following disclosure is directed to methods and systems for generating interactive videos and experiences and, more specifically, a discovery engine for interactive videos and experiences.

### BACKGROUND

Web sites often present information about a given product for the purpose of selling the product to a customer of the website. Some of these websites include videos visually presenting the product (e.g., a new vehicle, a power tool, a toy, a bouquet of flowers, etc.). However, such videos are typically predetermined and unalterable by the video developer or the user.

### SUMMARY

At least one aspect of the present disclosure is directed to a method for providing a discovery engine for filtering a plurality of items. The method includes displaying a first interactive module of a plurality of interactive modules to a user, receiving a first user interaction associated with the first interactive module, filtering the plurality of items based on the first interaction to provide a first group of items, displaying a second interactive module of the plurality of interactive modules to the user, receiving a second user interaction associated with the second interactive module, filtering the first group of items based on the second interaction to provide a second group of items, and displaying a third interactive module of the plurality of interactive modules, the third interactive module being configured to present at least a portion of the second group of items to the user as a recommended group of items.

In one embodiment, displaying the interactive modules includes displaying the interactive modules on at least one webpage configured to enable the user to purchase one or more items from the recommended group of items. In some embodiments, the method includes receiving a data structure including data corresponding to the plurality of interactive modules and the plurality of items. In certain embodiments, at least a portion of the data included in the data structure is dynamically updated via an application program interface (API) from at least one webpage associated with the plurality of items. In various embodiments, the data in the data structure corresponding to each item of the plurality of items includes at least one of: (a) an image of the item, (b) an inventory status of the item, (c) at least one priority weight associated with the item, or (d) at least one tag associated with the item.

In some embodiments, the data in the data structure corresponding to each module of the plurality of interactive modules includes at least one of: (a) a module type of the module, (b) video content associated with the module, (c) a user interface configuration of the module, or (d) at least one tag associated with the user interface configuration of the module. In one embodiment, the user interface configuration of the module includes two or more buttons included in the module and the at least one tag associated with the user interface configuration of the module includes at least one tag associated with each button of the two or more buttons. In various embodiments, the first user interaction corresponds to a selection of a first button in the first interactive module and filtering the plurality of items based on the first interaction includes assigning items from the plurality of items having the at least one tag associated with the first button to the first group of item, and the second user interaction corresponds to a selection of a second button in the second interactive module and filtering the first group of items based on the second interaction includes assigning items from the first group of items having the at least one tag associated with the second button to the second group of items. In certain embodiments, presenting at least a portion of the second group of items to the user as the recommended group of items includes assigning items from the second group of items to the recommended group of items based on the priority weight associated with each item.

In one embodiment, the priority weights of the plurality of items are scaled based on at least one of: (a) a manufacturer of the item, (b) a supplier of the item, (c) a promotion associated with the item, or (d) the inventory status of the item.

Another aspect of the present disclosure is directed to a system for providing a discovery engine for filtering a plurality of items. The system includes at least one memory for storing computer-executable instructions, and at least one processor for executing the instructions stored on the memory, wherein execution of the instructions programs the at least one processor to perform operations comprising: displaying a first interactive module of a plurality of interactive modules to a user, receiving a first user interaction associated with the first interactive module, filtering the plurality of items based on the first interaction to provide a first group of items, displaying a second interactive module of the plurality of interactive modules to the user, receiving a second user interaction associated with the second interactive module, filtering the first group of items based on the second interaction to provide a second group of items, and displaying a third interactive module of the plurality of interactive modules, the third interactive module being configured to present at least a portion of the second group of items to the user as a recommended group of items.

In one embodiment, displaying the interactive modules includes displaying the interactive modules on at least one webpage configured to enable the user to purchase one or more items from the recommended group of items. In some embodiments, the operations include receiving a data structure including data corresponding to the plurality of interactive modules and the plurality of items. In various embodiments, at least a portion of the data included in the data structure is dynamically updated via an application program interface (API) from at least one webpage associated with the plurality of items. In certain embodiments, the data in the data structure corresponding to each item of the plurality of items includes at least one of: (a) an image of the item, (b) an inventory status of the item, (c) at least one priority weight associated with the item, (d) filter criteria associated with the item, or (e) at least one tag associated with the item.

In some embodiments, the data in the data structure corresponding to each module of the plurality of interactive modules includes at least one of: (a) a module type of the module, (b) video content associated with the module, (c) a user interface configuration of the module, or (d) at least one tag associated with the user interface configuration of the module. In one embodiment, the user interface configuration of the module includes two or more buttons included in the module and the at least one tag associated with the user interface configuration of the module includes at least one tag associated with each button of the two or more buttons. In certain embodiments, the first user interaction corresponds to a selection of a first button in the first interactive module and filtering the plurality of items based on the first interaction includes assigning items from the plurality of items having the at least one tag associated with the first button to the first group of item, and the second user interaction corresponds to a selection of a second button in the second interactive module and filtering the first group of items based on the second interaction includes assigning items from the first group of items having the at least one tag associated with the second button to the second group of items. In various embodiments, presenting at least a portion of the second group of items to the user as the recommended group of items includes assigning items from the second group of items to the recommended group of items based on the priority weight associated with each item.

In one embodiment, the priority weights of the plurality of items are scaled based on at least one of: (a) a manufacturer of the item, (b) a supplier of the item, (c) a promotion associated with the item, or (d) the inventory status of the item.

Further aspects and advantages of the invention will become apparent from the following drawings, detailed description, and claims, all of which illustrate the principles of the invention, by way of example only.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 depicts a high-level system architecture for providing interactive media content according to an implementation.

FIG. 2 is a flowchart of an example method for generating an interactive video on an automated platform.

FIG. 3 is a diagram of an example system including the automated platform.

FIG. 4A is a diagram illustrating example video section types for use in the example system of FIG. 3.

FIG. 4B is a diagram of an example project formed from five video sections.

FIG. 4C is a diagram of an example template for an interactive video.

FIG. 5A is a diagram of an example template organized serially for selecting features of a particular product.

FIG. 5B is a diagram of a tree structure associated with the example template of FIG. 5A.

FIG. 6A is a diagram of an example template in which an interactive video enables multiple items to be selected.

FIG. 6B provides a shopping list that may be compiled based on the end user selections made in the interactive video of FIG. 6A.

FIG. 7 is a diagram of an example of a template in which an interactive video enables a recommendation of one or more items to be presented to the end user.

FIG. 8A is a diagram illustrating example interactive module types for use in the example system of FIG. 3.

FIG. 8B is a diagram of an example project formed from interactive modules.

FIG. 8C is a diagram of an example project formed from interactive modules and video sections.

FIG. 9 is a diagram of an example navigation menu for a project formed from interactive modules.

FIG. 10A is a diagram illustrating the adding of buttons into an example interactive module.

FIG. 10B is a diagram illustrating the adding of modules into an example discovery engine.

### DETAILED DESCRIPTION

Disclosed herein are exemplary embodiments of systems and methods for generating interactive videos. In particular, described are various embodiments of an automated platform for generating interactive videos.

### High-Level System Architecture

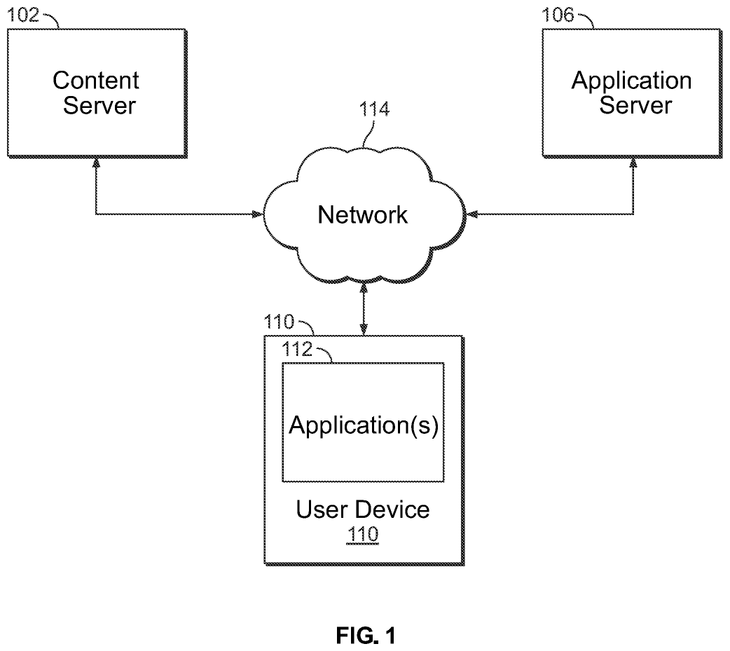

FIG. 1 depicts a high-level architecture of such a system according to an implementation. A media presentation having multiple video and/or audio streams can be presented to a user on a user device 110 having one or more application(s) 112 that together are capable of playing and/or editing the content and displaying a video library where information associated with videos can browsed and videos can be selected for playback. The user device 110 can be, for example, a smartphone, tablet, laptop, desktop, palmtop, television, gaming device, virtual reality headset, smart glasses, smart watch, music player, mobile telephone, workstation, or other computing device configured to execute the functionality described herein. The user device 110 can have output functionality (e.g., display monitor, touchscreen, image projector, etc.) and input functionality (e.g., touchscreen, keyboard, mouse, remote control, etc.).

The application 112 can be a video player/editor and library browser that is implemented as a native application, web application, or other form of software. In some implementations, the application 112 is in the form of a web page, widget, and/or Java, JavaScript, .Net, Silverlight, Flash, and/or other applet or plug-in that is downloaded to the user device 110 and runs in conjunction with a web browser. The application 112 and the web browser can be part of a single client-server interface; for example, the application 112 can be implemented as a plugin to the web browser or to another framework or operating system. Any other suitable client software architecture, including but not limited to widget frameworks and applet technology, can also be employed.

Media content can be provided to the user device 110 by content server 102, which can be a web server, media server, a node in a content delivery network, or other content source. In some implementations, the application 112 (or a portion thereof) is provided by application server 106. For example, some or all of the described functionality of the application 112 can be implemented in software downloaded to or existing on the user device 110 and, in some instances, some or all of the functionality exists remotely. For example, certain video encoding and processing functions can be performed on one or more remote servers, such as application server 106. In some implementations, the user device 110 serves only to provide output and input functionality, with the remainder of the processes being performed remotely.

The user device 110, content server 102, application server 106, and/or other devices and servers can communicate with each other through communications network 114. The communication can take place via any media such as standard telephone lines, LAN or WAN links (e.g., T1, T3, 56 kb, X.25), broadband connections (ISDN, Frame Relay, ATM), wireless links (802.11, Bluetooth, GSM, CDMA, etc.), and so on. The network 114 can carry TCP/IP protocol communications and HTTP/HTTPS requests made by a web browser, and the connection between clients and servers can be communicated over such TCP/IP networks. The type of network is not a limitation, however, and any suitable network can be used.

More generally, the techniques described herein can be implemented in any suitable hardware or software. If implemented as software, the processes can execute on a system capable of running one or more custom operating systems or commercial operating systems such as the Microsoft Windows® operating systems, the Apple OS X® operating systems, the Apple iOS® platform, the Google Android™ platform, the Linux® operating system and other variants of UNIX® operating systems, and the like. The software can be implemented a computer including a processing unit, a system memory, and a system bus that couples various system components including the system memory to the processing unit.

The system can include a plurality of software modules stored in a memory and executed on one or more processors. The modules can be in the form of a suitable programming language, which is converted to machine language or object code to allow the processor or processors to read the instructions. The software can be in the form of a standalone application, implemented in any suitable programming language or framework.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

It should also be noted that the present implementations can be provided as one or more computer-readable programs embodied on or in one or more articles of manufacture. The article of manufacture can be any suitable hardware apparatus, such as, for example, a floppy disk, a hard disk, a CD-ROM, a CD-RW, a CD-R, a DVD-ROM, a DVD-RW, a DVD-R, a flash memory card, a PROM, a RAM, a ROM, or a magnetic tape. In general, the computer-readable programs can be implemented in any programming language. The software programs can be further translated into machine language or virtual machine instructions and stored in a program file in that form. The program file can then be stored on or in one or more of the articles of manufacture.

### Media Presentations

The media presentations referred to herein can be structured in various forms. For example, a particular media presentation can be an online streaming video having multiple tracks or streams that a user can switch among in real-time or near real-time. For example, a media presentation can be structured using parallel audio and/or video tracks as described in U.S. patent application Ser. No. 14/534,626, filed on Nov. 6, 2014, and entitled “Systems and Methods for Parallel Track Transitions,” the entirety of which is incorporated by reference herein. More specifically, a playing video file or stream can have one or more parallel tracks that can be switched among in real-time automatically and/or based on user interactions. In some implementations, such switches are made seamlessly and substantially instantaneously, such that the audio and/or video of the playing content can continue without any perceptible delays, gaps, or buffering. In further implementations, switches among tracks maintain temporal continuity; that is, the tracks can be synchronized to a common timeline so that there is continuity in audio and/or video content when switching from one track to another (e.g., the same song is played using different instruments on different audio tracks; same storyline performed by different characters on different video tracks, and the like).

Such media presentations can also include interactive video structured in a video tree, hierarchy, or other form. A video tree can be formed by nodes that are connected in a branching, hierarchical, or other linked form. Nodes can each have an associated video segment, audio segment, graphical user interface (GUI) elements, and/or other associated media. Users (e.g., viewers) can watch a video that begins from a starting node in the tree and proceeds along connected nodes in a branch or path. Upon reaching a point during playback of the video where multiple video segments (child nodes) branch off from a segment (parent node), the user can interactively select the branch or path to traverse and, thus, the next video segment to watch.

As referred to herein, a particular branch or path in an interactive media structure, such as a video tree, can refer to a set of consecutively linked nodes between a starting node and ending node, inclusively, or can refer to some or all possible linked nodes that are connected subsequent to (e.g., sub-branches) or that include a particular node. Branched video can include seamlessly assembled and selectably presentable multimedia content such as that described in U.S. Patent application Ser. No. 13/033,916, filed on Feb. 24, 2011, and entitled “System and Method for Seamless Multimedia Assembly” (the “Seamless Multimedia Assembly application”), and U.S. patent application Ser. No. 14/107,600, filed on Dec. 16, 2013, and entitled “Methods and Systems for Unfolding Video Pre-Roll,” the entireties of which are hereby incorporated by reference.

The prerecorded video segments in a video tree or other structure can be selectably presentable multimedia content; that is, some or all of the video segments in the video tree can be individually or collectively played for a user based upon the user's selection of a particular video segment, an interaction with a previous or playing video segment, or other interaction that results in a particular video segment or segments being played. The video segments can include, for example, one or more predefined, separate multimedia content segments that can be combined in various manners to create a continuous, seamless presentation such that there are no noticeable gaps, jumps, freezes, delays, or other visual or audible interruptions to video or audio playback between segments. In addition to the foregoing, “seamless” can refer to a continuous playback of content that gives the user the appearance of watching a single, linear multimedia presentation, as well as a continuous playback of multiple content segments that have smooth audio and/or video transitions (e.g., fadeout/fade-in, linking segments) between two or more of the segments.

In some instances, the user is permitted to make choices or otherwise interact in real-time at decision points or during decision periods interspersed throughout the multimedia content. Decision points and/or decision periods can occur at any time and in any number during a multimedia segment, including at or near the beginning and/or the end of the segment. Decision points and/or periods can be predefined, occurring at fixed points or during fixed periods in the multimedia content segments. Based at least in part on the user's choices made before or during playback of content, one or more subsequent multimedia segment(s) associated with the choices can be presented to the user. In some implementations, the subsequent segment is played immediately and automatically following the conclusion of the current segment, whereas in other implementations, the subsequent segment is played immediately upon the user's interaction with the video, without waiting for the end of the decision period or the end of the segment itself.

If a user does not make a selection at a decision point or during a decision period, a default, previously identified selection, or random selection can be made by the system. In some instances, the user is not provided with options; rather, the system automatically selects the segments that will be shown based on information that is associated with the user, other users, or other factors, such as the current date. For example, the system can automatically select subsequent segments based on the user's IP address, location, time zone, the weather in the user's location, social networking ID, saved selections, stored user profiles, preferred products or services, and so on. The system can also automatically select segments based on previous selections made by other users, such as the most popular suggestion or shared selections. The information can also be displayed to the user in the video, e.g., to show the user why an automatic selection is made. As one example, video segments can be automatically selected for presentation based on the geographical location of three different users: a user in Canada will see a twenty-second beer commercial segment followed by an interview segment with a Canadian citizen; a user in the US will see the same beer commercial segment followed by an interview segment with a US citizen; and a user in France is shown only the beer commercial segment.

Multimedia segment(s) selected automatically or by a user can be presented immediately following a currently playing segment, or can be shown after other segments are played. Further, the selected multimedia segment(s) can be presented to the user immediately after selection, after a fixed or random delay, at the end of a decision period, and/or at the end of the currently playing segment. Two or more combined segments can form a seamless multimedia content path or branch, and users can take multiple paths over multiple playthroughs, and experience different complete, start-to-finish, seamless presentations. Further, one or more multimedia segments can be shared among intertwining paths while still ensuring a seamless transition from a previous segment and to the next segment. The content paths can be predefined, with fixed sets of possible transitions in order to ensure seamless transitions among segments. The content paths can also be partially or wholly undefined, such that, in some or all instances, the user can switch to any known video segment without limitation. There can be any number of predefined paths, each having any number of predefined multimedia segments. Some or all of the segments can have the same or different playback lengths, including segments branching from a single source segment.

Traversal of the nodes along a content path in a tree can be performed by selecting among options that appear on and/or around the video while the video is playing. In some implementations, these options are presented to users at a decision point and/or during a decision period in a content segment. Some or all of the displayed options can hover and then disappear when the decision period ends or when an option has been selected. Further, a timer, countdown or other visual, aural, or other sensory indicator can be presented during playback of content segment to inform the user of the point by which he should (or, in some cases, must) make his selection. For example, the countdown can indicate when the decision period will end, which can be at a different time than when the currently playing segment will end. If a decision period ends before the end of a particular segment, the remaining portion of the segment can serve as a non-interactive seamless transition to one or more other segments. Further, during this non-interactive end portion, the next multimedia content segment (and other potential next segments) can be downloaded and buffered in the background for later playback (or potential playback).

A segment that is played after (immediately after or otherwise) a currently playing segment can be determined based on an option selected or other interaction with the video. Each available option can result in a different video and audio segment being played. As previously mentioned, the transition to the next segment can occur immediately upon selection, at the end of the current segment, or at some other predefined or random point. Notably, the transition between content segments can be seamless. In other words, the audio and video continue playing regardless of whether a segment selection is made, and no noticeable gaps appear in audio or video playback between any connecting segments. In some instances, the video continues on to another segment after a certain amount of time if none is chosen, or can continue playing in a loop.

In one example, the multimedia content is a music video in which the user selects options upon reaching segment decision points to determine subsequent content to be played. First, a video introduction segment is played for the user. Prior to the end of the segment, a decision point is reached at which the user can select the next segment to be played from a listing of choices. In this case, the user is presented with a choice as to who will sing the first verse of the song: a tall, female performer, or a short, male performer. The user is given an amount of time to make a selection (i.e., a decision period), after which, if no selection is made, a default segment will be automatically selected. The default can be a predefined or random selection. Of note, the media content continues to play during the time the user is presented with the choices. Once a choice is selected (or the decision period ends), a seamless transition occurs to the next segment, meaning that the audio and video continue on to the next segment as if there were no break between the two segments and the user cannot visually or audibly detect the transition. As the music video continues, the user is presented with other choices at other decisions points, depending on which path of choices is followed. Ultimately, the user arrives at a final segment, having traversed a complete multimedia content path.

### Interactive Videos for Physical Items

In various embodiments, interactive videos may feature one or more physical items, e.g., for the purpose of selling the item, for educating a user about the item, for training a user about the item, etc. Example embodiments of the interactive videos may enable a user to interact with a representation of an item. In some embodiments, the interactive video may be configured such that the user is able to interact with the representation of the item within the video, outside of the video, adjacent to the video, etc.

For example, in the context of a product on sale (e.g., a car, a shirt, gym equipment, etc.), the video featuring the product may be configured to enable a user to interact with the representation of the product, the product's features, types of the product, options for the product, accessories for the product, other products similar and/or related to the product, etc. In this way, the user can explore and learn more about the product before making a purchasing decision. In another example, in the context of an educational video featuring a subject item, the video may be configured to present a representation of the subject item (e.g., a whale, a circuit, a plant, a book, etc.). The user (e.g., student, trainee, etc.) can interact with the subject item to learn more about and/or investigate the features of the subject item, reconfigurability of the item, etc. It is understood that, while this disclosure features systems and methods for generating interactive videos for products, the example systems and methods described herein can be applied to interactive videos featuring educational items, training items, items subject to investigation, items subject to analysis, etc.

In various embodiments, the interactive video can be included (integrated, embedded, etc.) in a website, an app for a mobile device, on an automated platform, etc. For example, the interactive video featuring a product may be on the product-specific webpage or a product detail page (PDP) of the app or platform. In another example, the interactive video can be part of a retail website (e.g., Nike.com, Toyota.com, Samsung.com, etc.) or a part of an online marketplace (e.g., Walmart.com, Amazon.com, etc.).

### Automated Platform and Related Methods

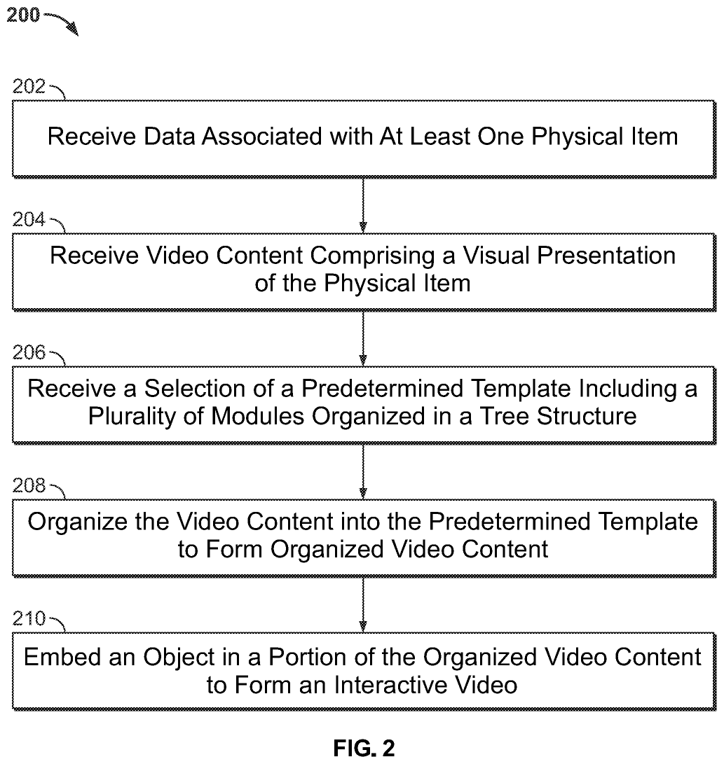

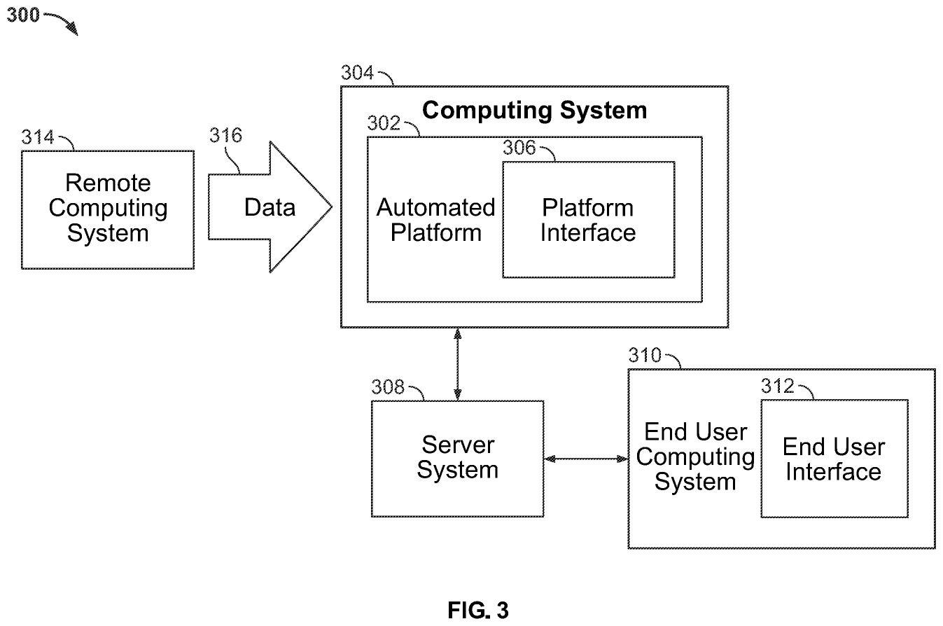

In various embodiments, an automated platform can be configured to generate an interactive video. FIG. 2 shows a flowchart of an example method for generating an interactive video on an automated platform. FIG. 3 illustrates a diagram of an example system including the automated platform. For the sake of clarity and conciseness, FIGS. 2-3 are discussed together herein. The term “publisher” is used to refer to the user that is involved in generating the interactive videos and the term “end user” is used to refer to the user that interacts with the interactive videos.

Referring to FIG. 3, the example system 300 may include an automated platform 302 hosted on a computing system 304. In some embodiments, the automated platform 302 includes a platform interface 306. A server system 308 may be configured to be connected (e.g., via an

API, via the cloud, a computer network, etc.) to the computing system 304. The server system 308 may be configured to be connected (e.g., via an API, via the cloud, a computer network, etc.) to an end user computing system 310. The end user computing system 310 may have an end user interface 312. The end user computing system 310 may be a mobile device, a smartphone, a tablet computer, a laptop computer, a notebook computer, a set of smart glasses, a smart watch, a headset, etc. Note that the system 300 may be communicably connected (e.g., via an API, via the cloud, a computer network, etc.) to other computing systems, e.g., remote computing system 314.

In step 202, the system 300 (e.g., automated platform 302) can be configured to receive data 316 associated with at least one physical item. The received data 316 may be streamed, received via an application programming interface (API), received in one or more data files, and/or received in a bulk data transfer. The received data 316 to may be inputted by the publisher and/or obtained from a remote computing system 314. For example, the data 316 may include an identification number or code associated the item (e.g., a stock keeping unit (SKU), an ID number, etc.), a link to a website (e.g., a URL) associated with the item, a text description associated with the item, one or more tags associated with the item, a list of features associated with the item, one or more images of the item, one or more videos associated with the item, one or more videos associated with the item feature, one or more audio data associated with the item, and/or one or more audio data associated with the item features. For example, the received data 316 for a particular product may include a product name, one or more pictures of the product, customer reviews of the product, a product description, inventory status, one or more tags, an identification number, etc. As described further below, one or more of these data may be used or presented in or adjacent to the interactive video featuring the product item.

In step 204, the system 300 can be configured to receive video content including a visual presentation of one or more physical items. In some embodiments, the interactive video features one item. In some embodiments, the interactive video features two or more options (e.g., color, size, similar products, etc.) for the same item. In some embodiments, the interactive video features two or more items. For example, an interactive video can feature a cooking video with a grocery shopping list of ingredients used in the video. In another example, an interactive video for skiing or snowboarding can feature multiple pieces of clothing, equipment, accessories, etc. for purchase.

In step 206, the system 300 can be configured to receive a selection of a predetermined template. The predetermined template may include two or more video sections organized in a tree structure. Note that the system 300 may store and/or reference one or more templates based on the item, a feature of the item, a tag associated with the item, the publisher's preference, etc. Different templates may be associated with different tree structures, may have different appearances, and/or accommodate different data (e.g., video, audio, etc.) associated with the item. The publisher can select an appropriate template for a given item; add, remove, or adjust video sections; adjust the associated tree structure; add, remove, or adjust the data in the template.

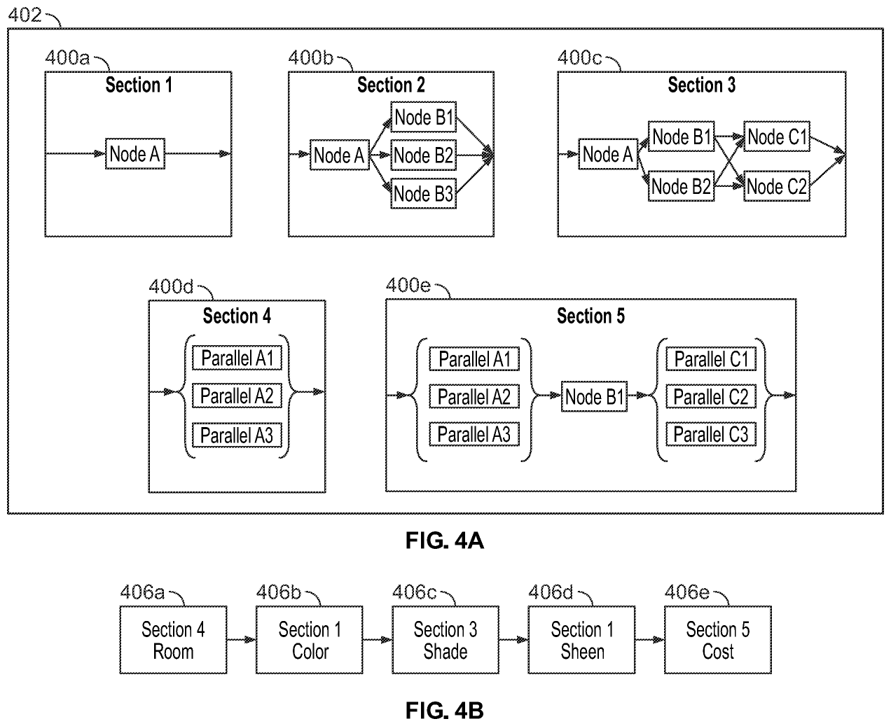

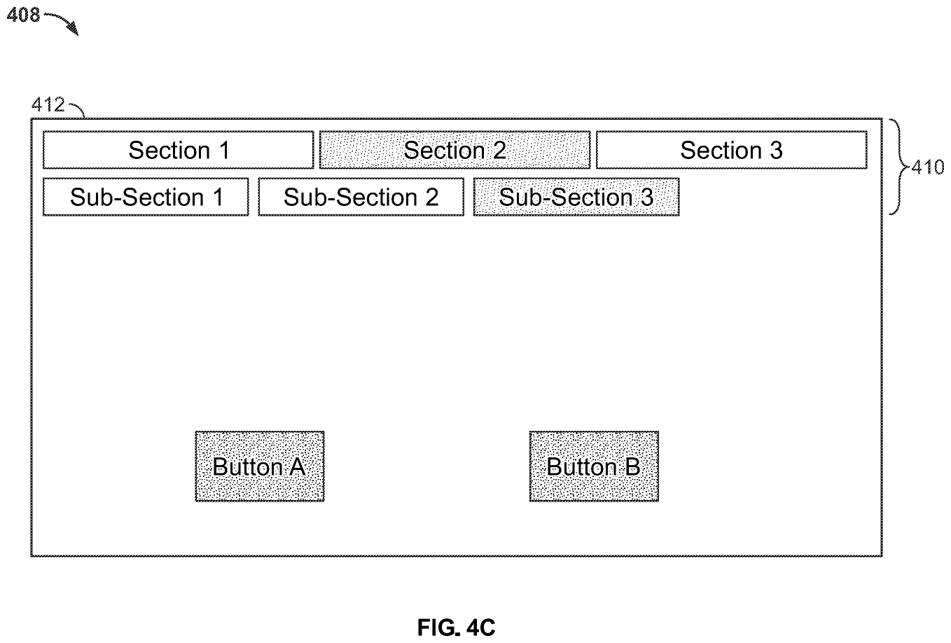

FIG. 4A illustrates example video section types for use in system 300. A given video section may include one or more nodes arranged in a tree structure. Illustrated are video section type 1 (400a ), video section type 2 (video section 400b ), video section type 3 (video section 400c ), video section type 4 (video section 400d ), and video section type 5 (video section 400e ) (collectively referred as video section types 400). It is understood that other types and/or configurations of video sections are within the scope of this disclosure. For instance, video section type 1 may include a single node A having an input (connected to the input of the video section 400a ) and an output (connected to the output of the video section 400a ). Video section type 2 may include node A having an input (connected to the input to the video section 400b ) and an output connected to the inputs of nodes B1, B2, and B3. Nodes B1, B2, and B3 can be arranged in parallel. The outputs of nodes B1, B2, and B3 can form the output of video section 400b . Video section type 3 may include a node A having an input (connected to the input of the module 400c ) and an output connected to the inputs of node B1 and node B2 (which can be arranged in parallel to one another). The outputs of node B1 and node B2 can be connected to the inputs of node C1 and node C2. The outputs of node C1 and node C2 can be connected to the output of video section 400c . Video section type 4 may include parallel node A1, node A2, and node A3. The input of video section 400d can be connected to one or more of the parallel nodes and the output of one or more of the parallel nodes can be connected to the output of the video section 400d . Video section type 5 can include parallel node A1, node A2, and node A3. The input of video section 400e can be connected to one or more of the parallel nodes A1, A2, A3. The output of one or more of the parallel nodes can be connected to the input of node B1. The output of node B1 can be connected to one or more of the inputs of parallel nodes C1, C2, C3. The outputs of parallel nodes C1, C2, C3 can be connected to the output of video section 400e . In various embodiments, one or more video sections 400 of types 1-5 can be part of a project workspace 402. These video sections 400 can be selected and/or organized by a user (e.g., a publisher) working in the project workspace 402.

FIG. 4B illustrates an example project 404 formed from five video sections. In this example, the project 404 is for an interactive video enabling the selection of a wall paint. The project includes video section 406a (of type 4) enabling the selection of a room (e.g., in a residence); video section 406b (of type 1) enabling the selection of a color; video section 406c (of type 3) enabling the selection of a shade; video section 406d (of type 1) enabling the selection of a sheen; and video section 406e (of type 5) enabling the selection of cost.

FIG. 4C illustrates an example template 408. As illustrated, the template 408 includes an index of video sections at the top 410 of the frame 412. The interactive video may play inside the frame 412 as it is being configured for interactivity. The example template 408 may include two or more video sections (e.g., Section 1, Section 2, Section 3), two or more video sub-sections (e.g., Sub-Section 1, Sub-Section 2, Sub-Section 3), and two or more buttons (e.g., Button A,

Button B). The video sections and/or the video sub-sections can each be associated with a particular interactive aspect of the interactive video. The buttons can be configured by the publisher to enable a user select a feature or option in the interactive video.

In step 208, the system 300 can be configured to organize the video content into the predetermined template to form organized video template. In some embodiments, the video content may be received in portions and/or divided into portions after receipt. These video content portions may be organized into video sections (and/or video sub-sections). For example, a template for an interactive video featuring a toy may organize received video content such that the interactive video includes a first video section for unboxing the toy, a second video section for playing with the toy, and exploring the features of the toy. In another example, a template for an interactive video featuring a fashion product (e.g., clothes, accessories, shoes, etc.) may include a first video section for the user to select a fashion influencer, a second video section to view a product associated with the influencer, a third video section to select a color, and a fourth video section to select a color.

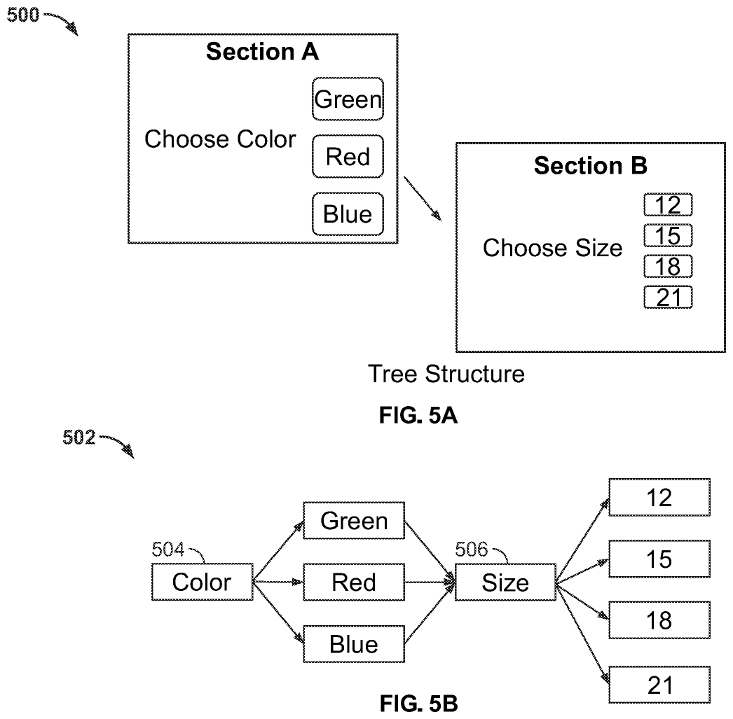

In step 210, an object (e.g., a button, an interactive element, a slide, etc.) may be embedded in a portion of the video content (e.g., in a video section) to enable the end user to interact with the video. FIG. 5A illustrates example template 500 (or part of a template) organized serially (e.g., sequentially, in time, etc.) for selecting features of a particular product (e.g., item of clothing). The template 500 includes a first video section (Section A) in which the end user is prompted to select a color of the product (e.g., green, red, or blue) and a second video section (Section B) in which the end user is prompted to select a size of the product (e.g., 12, 15, 18, 21). As illustrated in FIG. 5B, the tree structure 502 is arranged such that the color branch 504 splits into three branches (one for each color green, red, blue). The color branches lead to the size branch 506, which splits into four branches (one for size 12, size 15, size 18, and size 21).

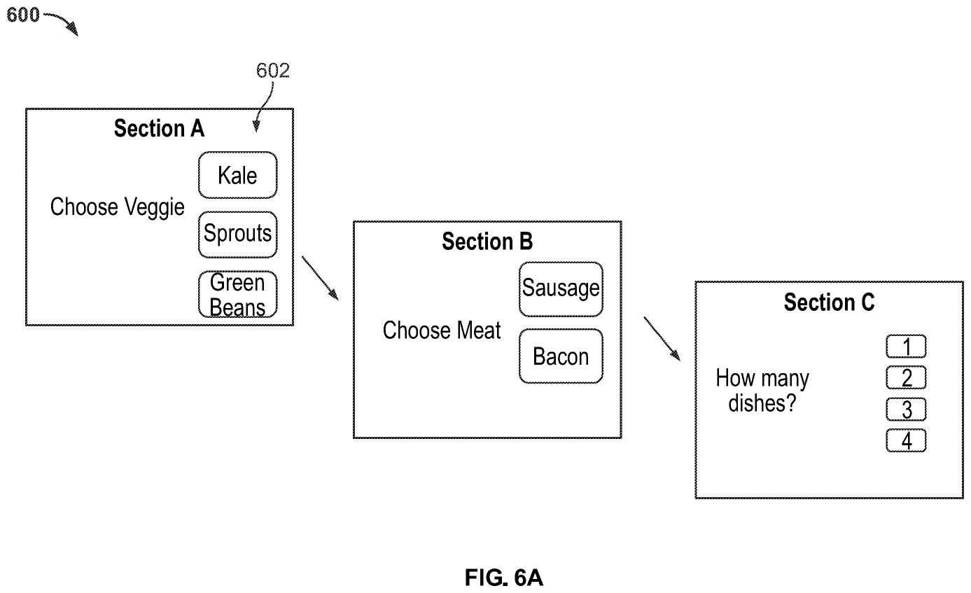

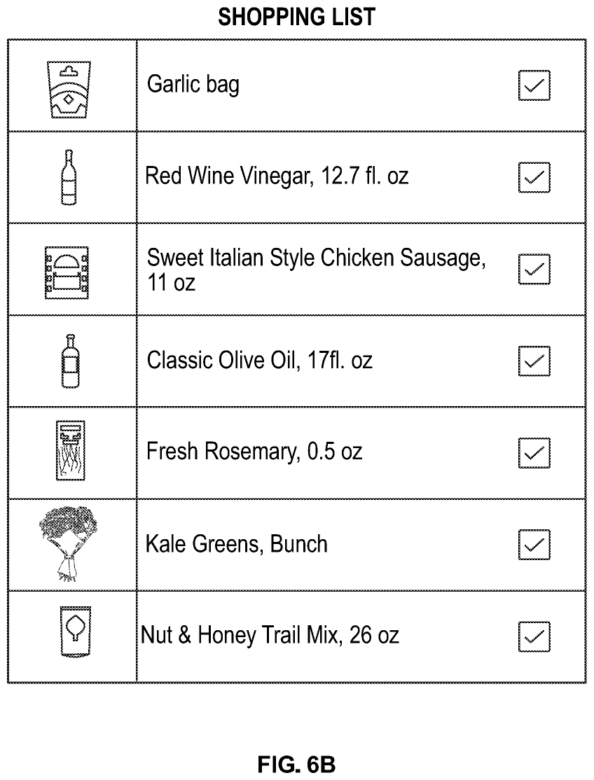

FIG. 6A provides an example template 600 in which an interactive video enables multiple items to be selected. In this example, each video section may include a video content portion associated with a food (e.g., a segment of a cooking video in which one or more ingredients are added). Therefore, in Section A, a video portion (e.g., associated with a vegetable component) may play and buttons (e.g., to types of vegetables respectively) may appear before, during, or after the video portion plays. Once a selection is made (e.g., button “Kale”), the interactive video moves to the next video section having the next video content portion (e.g., associated with a meat component). Again, a selection of a button (e.g., sausage) is made and the video content in Section C is played. Note that this sequence may include more or less video sections. The video sections may be of different lengths. For example, FIG. 6B provides a shopping list that may be compiled based on the end user selections made in previous video sections. It is understood that a similar list may be compiled based on an interactive video for winter sports equipment, a car with trim options, a product with various configurations, etc.

In some embodiments, the interactive video may be configured to wait for end user interaction (e.g., via a button) to move to the next video section. In some embodiments, the interactive video may be configured to automatically select a button for the end user after some time period (or make no selection) and move to the next video section.

### Discovery Engine and Related Methods

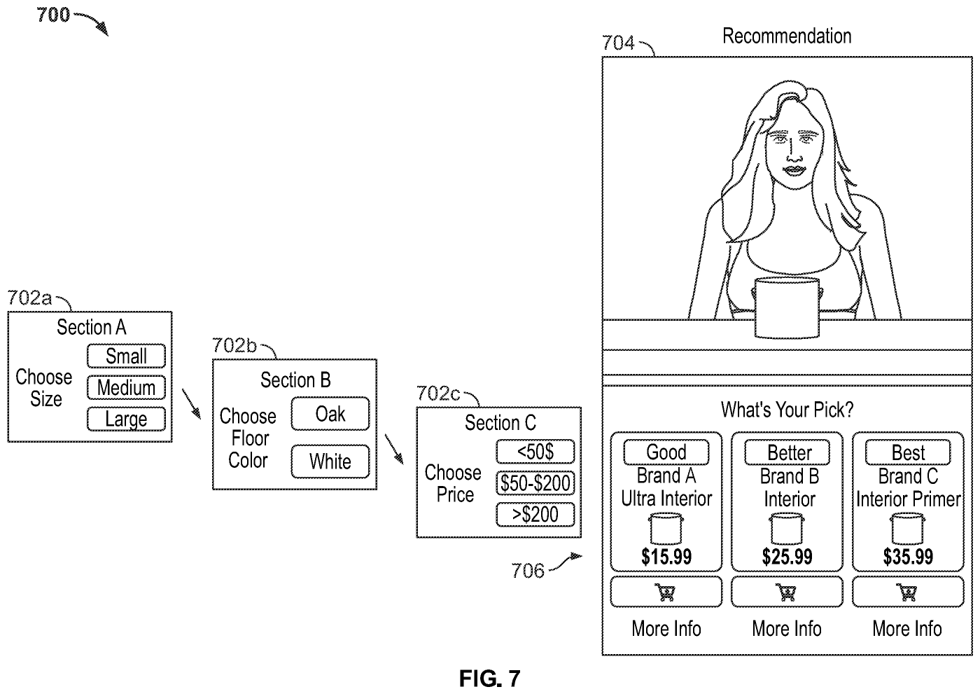

In one example, the interactive video can be used to filter a plurality of items (or products) down to a personalized group of items for the end user. FIG. 7 illustrates an example template 700 in which an interactive video enables a recommendation of one or more items to be presented to the end user. In some examples, the interactive video corresponds to a discovery engine configured to recommended items to the end user based on preferences of the end user. In one example, the discovery engine starts with a large list of items and narrows the large list down to a small list of items based on selections made by the end user during the interactive video.

In the illustrated example, each video section may include a video content portion associated with the selection of paint for a room (e.g., for walls of a room). For example, in a first video section 702a , a video portion (e.g., associated with a size of the paint item) may play and buttons (e.g., to different item sizes respectively) may appear before, during, or after the video portion plays. Once a selection is made (e.g., button “Medium”), the interactive video moves to a second video section 702b having the next video content portion (e.g., associated with a floor color of the room). Again, a selection of a button (e.g., button “Oak”) is made and the video portion (e.g., associated with a cost of the paint item) in a third video section 702c is played. Once a selection of a button (e.g., button “$50-$200”) is made, the interactive video can display recommended items to the user. In one example, the interactive video is configured to display (or link to) a recommendation module 704. As shown, the recommendation module 704 can include a plurality of items (e.g., paint cans) 706 that are provided as recommendations to the end user based on the selections made with respect to video sections 702a , 702b , and 702c of the interactive video. Note that this sequence may include more or less video sections. The video sections may be of different lengths.

As described above, the system 300 can provide interactive videos corresponding to the sequences of video section. In some examples, the system 300 can be configured to provide interactive experiences including one or more interactive modules. The interactive modules may correspond to “building blocks” that can be re-used across different types of interactive experiences and/or within the same interactive experiences. Similar to the sections described above (e.g., Sections 1-5 of FIG. 4A), the interactive modules can be connected to each other with different configurable variations. The interactive modules may include various assets that can be configured by the publisher. For example, the configurable assets may include text, videos, pictures, buttons, colors, themes, add-ons, extensions, etc.

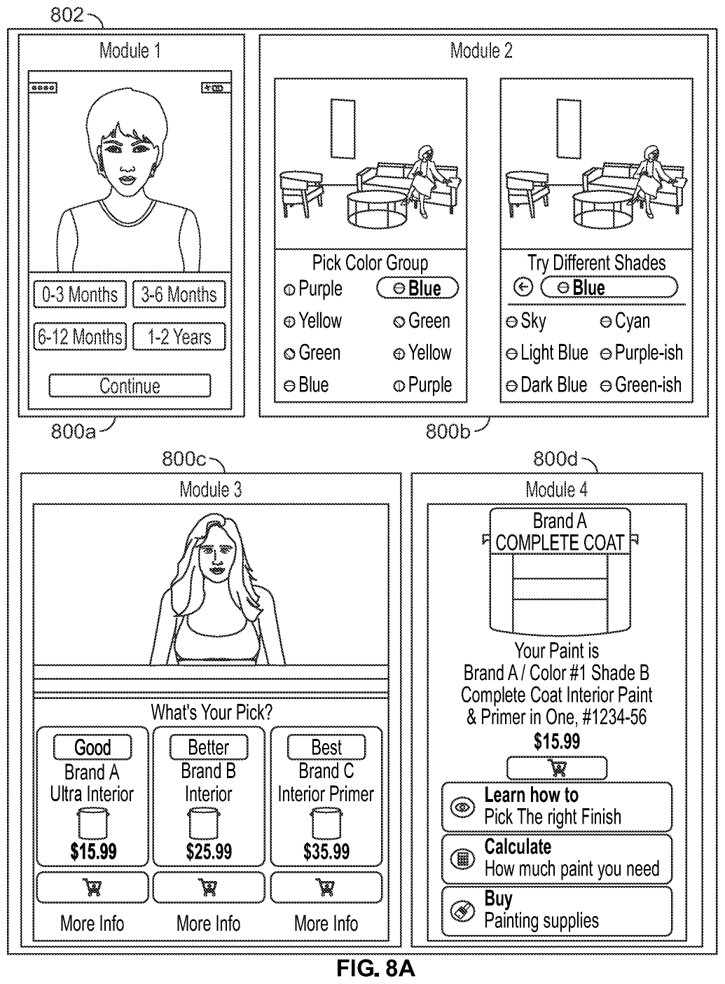

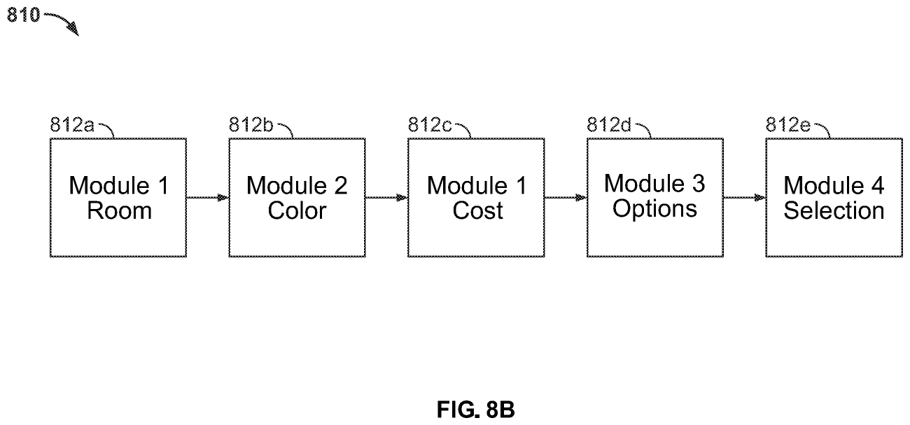

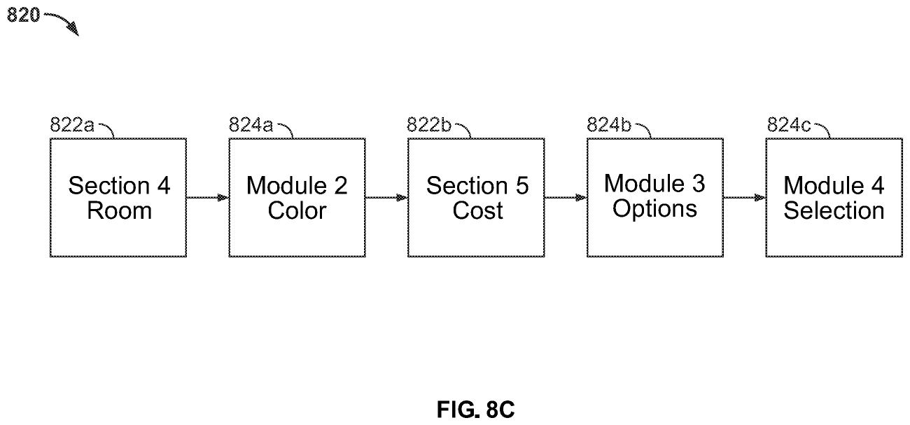

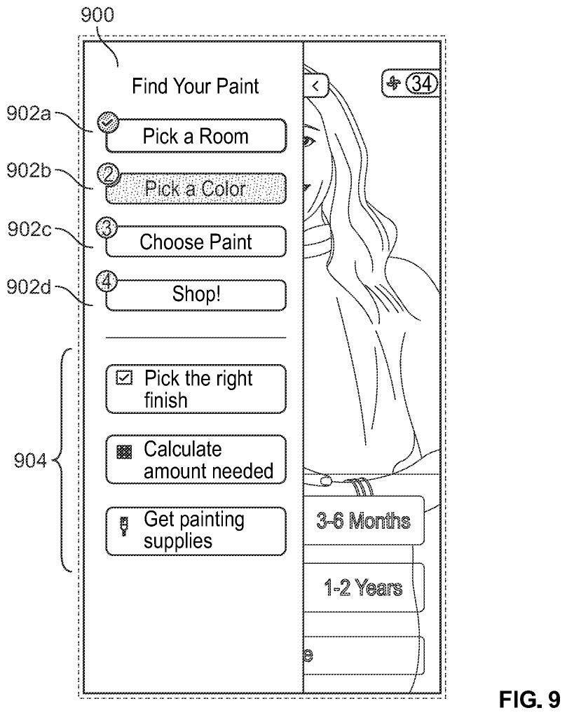

FIG. 8A illustrates example interactive module types for use in system 300. Illustrated are module type 1 (800a ), module type 2 (module 800b ), module type 3 (module 800c ), and module type 4 (module 800d ) (collectively referred as module types 800). It is understood that other types and/or configurations of modules are within the scope of this disclosure. For instance, module type 1 corresponds to a single-step module. In one example, the single-step module is configured to present the end user with two or more options and receive a selection of at least one option from the end user before ending the module. Likewise, module type 2 corresponds to a two-step module. In one example, the two step-module is configured to present a first set of options (e.g., two or more options), receive a selection of at least one option from the first set of options, present a second set of options, and receive a selection of at least one option from the second set of options before ending the module. In some examples, the second set of options presented to the end user correspond to the one to more options selected from the first set of options. For example, the first set of options may represent colors of paint and the second set of options may represent various shades of the selected color. Module type 3 corresponds to a recommendation module (e.g., recommendation module 704 of FIG. 7). In one example, the recommendation module is configured to present two or more recommended items (or products) and receive a selection of at least one item before ending the module. Module type 4 corresponds to a product focus module. In one example, the product focus module is configured to provide information associated with a specific product and/or describe the functionality of a specific product. In some examples, the product focus module can pull information associated with products (or items) included in a database or data structure for an online store, marketplace, or website. The product focus module may include buttons (or links) corresponding to additional features associated with the product (or item). For example, the additional features may include instructions for selecting the proper item variant (e.g., type of paint), a calculator tool for determining a quantity of the item needed (e.g., how much paint), a link to purchase the item (or add to an online shopping cart), and a link to view (or purchase) related items or products (e.g., paint brushes, ladders, etc.). In various embodiments, one or more modules 800 of types 1-4 can be part of a project workspace 802. These modules 800 can be selected and/or organized by a user (e.g., a publisher) working in the project workspace 802.

FIG. 8B illustrates an example project 810 formed from five modules. In one example, the project 810 corresponds to a discovery engine that enables a user to select a paint item. The project 810 includes module 812a (of type 1) enabling the selection of a room (e.g., in a residence); module 812b (of type 2) enabling the selection of a color; module 812c (of type 1) enabling the selection of a project cost; module 812d (of type 3) for providing one or more recommended paint options from a plurality of paint options; and module 812e (of type 4) for enabling the viewing and/or purchasing of a selected paint item. While the project 810 of FIG. 8B corresponds to an interactive experience including a plurality of interactive modules, it should be appreciated that the project can be configured to include both interactive modules and video sections. For example, FIG. 8C illustrates an example project 820 formed from three interactive modules and two video sections. In one example, the project 820 corresponds to a discovery engine that enables a user to select a paint item. The project 820 includes video section 822a (of type 4) enabling the selection of a room (e.g., in a residence); module 824a (of type 2) enabling the selection of a color; video section 822b (of type 5) enabling the selection of a project cost; module 824b (of type 3) enabling the selection of a recommended paint option; and module 824c (of type 4) enabling the viewing and/or purchasing of the selected paint option.

As described above, the discovery engine (e.g., project 810) can be used to filter a plurality of items (or products) down to a personalized group of items for the end user. The discovery engine can be defined by a project content management structure (CMS) that is configured by the publisher and/or automatically by the system 300. The project CMS may be a database or data structure stored in memory and/or on one or more local or cloud-based servers.

In one example, the project CMS includes a project name (e.g., project ID) and user details. The user details may include information provided by the end user and/or information that has been collected from the end user's interactions on a website hosting the discovery engine. The project CMS includes a list (or sequence) of module sub-structures corresponding to each module included in the discovery engine. In one example, each module sub-structure includes the module type (e.g., modules 1-4 of FIG. 8A), video content, and button parameters (e.g., text, position, etc.). In some examples, the button parameters can include item tag labels and add/remove filter settings, as described in greater detail below. The project CMS includes a list of item sub-structures corresponding to the plurality of items (or products) that the discovery engine is configured to filter. In one example, each item sub-structure includes an item ID, a label (e.g., item name or description), an image of the item, item tag labels, item tag weights, filter criteria, an item link (e.g., URL), a video associated with the item, a price, and an availability status (e.g., in stock, out of stock, etc.).

The item tag labels, item tag weights, and filter criteria included in each item sub-structure can be used by the project CMS and/or the modules of the discovery engine to filter the plurality of items down to the personalized group of items. The item tag labels can include one or more identifying labels that describe the item (e.g., metatags). For example, if the end user selects the paint color “blue” in a module (e.g., via a button), each item having relevant tag labels (e.g., “blue,” “paint,” etc.) can be identified by the project CMS and/or the module. As such, items corresponding to different shades of blue paint may be further filtered by subsequent modules of the discovery engine. Likewise, the filter criteria included in each item sub-structure can be used to determine which items apply to various filters selected by the end user. For example, if the end user selects a cost of “less than $50” in a module (e.g., via a button), each item having relevant filter criteria (e.g., “less than $50,” “less than $25,” etc.) can be identified by the project CMS and/or the module and further filtered by subsequent modules of the discovery engine. In some examples, selecting a button in a module causes certain filters to be added or removed to the plurality of items (e.g., based on the filter criteria associated with each item). In some examples, the project CMS may apply filters that are not associated with the modules. For examples, the project CMS may filter the items based item inventory status, item price, and/or promotions using information sourced from the website via an application programming interface (API).

The items included in the project CMS can be sorted and filtered by the modules until the personalized group of items has been determined. In one example, the personalized group of items corresponds to a plurality of qualifying items (or item sub-structures) that meet all of the filtering criteria and include all of the item tags added during the sequence of modules. As described above, the personalized group of items can be presented to the end user via one of the modules (e.g., the recommendation module 800c ). In one example, the recommendation module 800c is configured to display a specific amount recommended items (e.g., one, four, etc.). The number of items recommended can be fixed or dynamically adjusted via the module sub-structure corresponding to the recommendation module 800c.

In some examples, the recommended items are selected from the plurality of qualifying items based on the item tag weights (e.g., priority weights). For example, the item tag weights can be scaled for each item based on various preferences of the end user and/or the publisher (or the website). In one example, the weights may be scaled to favor items produced by preferred manufacturers or supplied by preferred suppliers. In other examples, the weights may be scaled based on item inventory, item price, and/or promotions. As such, if the plurality of qualifying items exceeds the number of items to be recommended (e.g., four items), the qualifying items having the biggest weighting may be selected as the recommended items. In the event there are too many qualifying items with the same weighting (or substantially the same weighting), one or more of the recommended items can be randomly picked from the qualifying items with the same weighting. In some examples, if the number of qualifying items exceeds a predetermined threshold (e.g., eight items), the content manager (or publisher) associated with the project CMS may be notified (e.g., via email). The content manager can receive the notification and may adjust the configuration of the project CMS accordingly. For example, the content manager may adjust the item tag labels, item tag weights, and/or filter criteria included in one or more of the item sub-structures. Likewise, if the number of qualifying items is less than the desired amount of recommended items, the content manager may be notified and adjustments can be made accordingly.

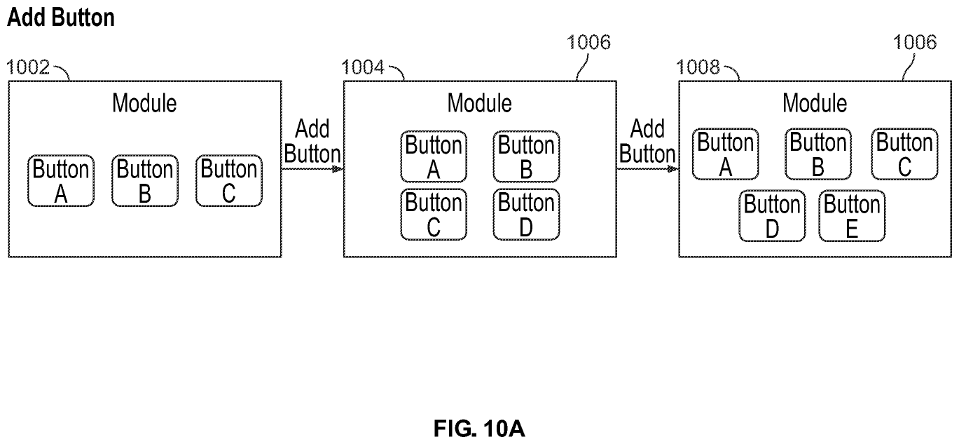

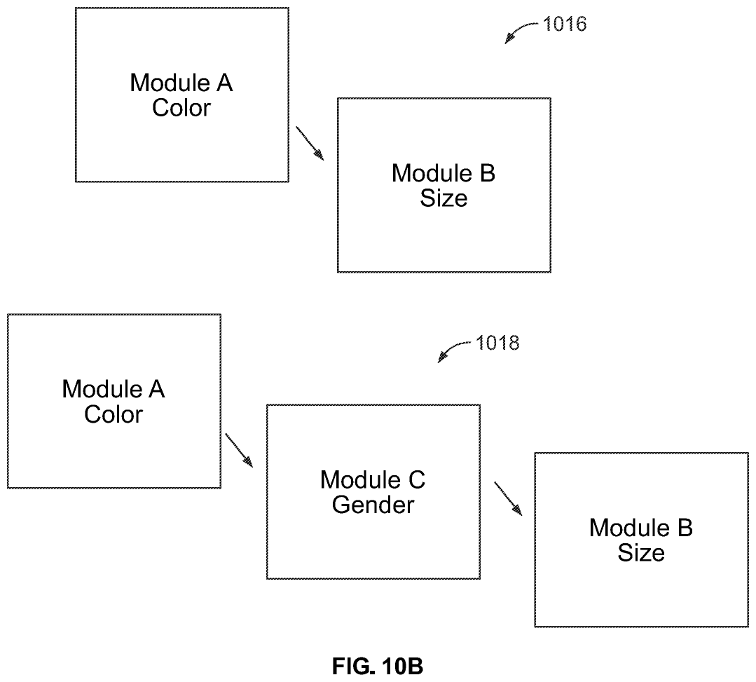

In some examples, when included in a project (e.g., projects 810, 820), each module may include add-ons to assist the end user during the interactive experience. For example, each module can include an indication button showing where the user is in the interactive experience (e.g., what step or stage), a back button that enables the user to return to the previous module, and a next button that enables the user to advance to the next module. In some examples, each module includes a navigation menu that displays each module of the interactive experience (e.g., each step or stage) and enables the user to navigate to a specific module. FIG. 9 illustrates an example navigation menu 900. As shown, the navigation menu 900 can display module buttons 902 corresponding to each module included in the project. In some examples, the module buttons 902 can have different appearances based on the state of each module. For example, the buttons corresponding to completed modules may be highlighted by a specific color (e.g., green) and may display a check mark (e.g., module button 902a ). Likewise, the button corresponding to the current (or active) module may be highlighted or shaded black (e.g., module 902b ). In some examples, the buttons 902 corresponding to upcoming (or uncompleted) modules may be unhighlighted (e.g., module buttons 902c , 902d ). In some examples, the user may select the module buttons 902 to navigate between the different modules included in the project. In certain examples, the navigation menu 900 may include one or more buttons 904 that enable the user to select additional features (e.g., instructions for selecting the proper item variant, a calculator tool for determining a quantity of the item needed, etc.). The navigation menu 900 may include a restart button that enables the user to restart the interactive experience. In some examples, the current module (or associated video) is paused and/or darkened while the navigation menu 900 is open. In some embodiments, the interactive experience (e.g., modules) may be altered before, during, or after the experience is “live” on a website. For example, one or more aspects of the modules (e.g., buttons, timeline, video content, data) and/or the project CMS may be adjusted. FIG. 10A illustrates the adding of buttons into an interactive module 1002. In this example, the interactive module 1002 includes buttons A, B, and C. The publisher can add a button D to create 1004. In some embodiments, the project CMS is configured to enable the buttons A, B, C, and D to distribute automatically based on their number over the area inside the frame 1006. Adding a button to module 1004 causes the arrangement displayed in module 1008, in which the five buttons are distributed in the frame 1006. In some embodiments, this predetermined distribution of buttons is adjustable by the publisher (e.g., via the project CMS). Note that the buttons described herein may be positioned anywhere within a frame (e.g., of the interactive module, of the player of the module, etc.), at the perimeter of the module, outside the module on the webpage.

The publisher (or content manager) can choose to add or subtract modules from an interactive experience For example, FIG. 10B illustrates an embodiment in which a module is added to an arranged sequence (e.g., a discovery engine). In particular, an interactive experience 1016, Module A (selecting a color of the item) passes to Module B (selecting a size of the item).

The project CMS (or the platform 302) enables the publisher to add a module between Modules A and B. For example, a new Module C (selecting a gender) is added between selecting a color in Module A and selecting a size in Module B. In some examples, the publisher (or content) manager may choose to add or subtract modules from the discovery engine to adjust the results of the discovery engine (e.g., the qualifying or recommended items).

In some embodiments, the project CMS may be used to embed the interactive experience into a webpage and may be configured to be “overridden” by data associated with the webpage. For instance, the module and item sub-structures can include placeholder sections, buttons, fields, video content, images, etc. The project CMS may then be overridden by the website in real time or near real time. In addition, the data included in the project CMS (e.g., the module and item sub-structures) can be dynamically updated from the website via the API. The features of the project CMS that can be overridden may be included in metadata associated with the items and/or webpage carrying the items. A publisher may choose to embed the interactive experience into multiple webpages (e.g., each webpage featuring a different model of a shoe, an online marketplace featuring a wide variety of products, etc.) and override the project CMS with content and/or configurations specific to the item on that webpage. In some embodiments, the configuration of interactive experience, video content, and/or related data can be stored within data of the webpage.

### Terminology

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or

“X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of.” “Consisting essentially of,” when used in the claims, shall have its ordinary meaning as used in the field of patent law. As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A method for providing a discovery engine for filtering a plurality of items, the method comprising:
displaying a first interactive module of a plurality of interactive modules to a user;
receiving a first user interaction associated with the first interactive module;
filtering the plurality of items based on the first interaction to provide a first group of items;
displaying a second interactive module of the plurality of interactive modules to the user;
receiving a second user interaction associated with the second interactive module;
filtering the first group of items based on the second interaction to provide a second group of items; and
displaying a third interactive module of the plurality of interactive modules, the third interactive module being configured to present at least a portion of the second group of items to the user as a recommended group of items.

2. The method of claim 1, wherein displaying the interactive modules includes displaying the interactive modules on at least one webpage configured to enable the user to purchase one or more items from the recommended group of items.

3. The method of claim 1, further comprising:
receiving a data structure including data corresponding to the plurality of interactive modules and the plurality of items.

4. The method of claim 3, wherein at least a portion of the data included in the data structure is dynamically updated via an application program interface (API) from at least one webpage associated with the plurality of items.

5. The method of claim 3, wherein the data in the data structure corresponding to each item of the plurality of items includes at least one of:
(a) an image of the item;
(b) an inventory status of the item;
(c) at least one priority weight associated with the item; or
(d) at least one tag associated with the item.

6. The method of claim 5, wherein the data in the data structure corresponding to each module of the plurality of interactive modules includes at least one of:
(a) a module type of the module;
(b) video content associated with the module;
(c) a user interface configuration of the module; or
(d) at least one tag associated with the user interface configuration of the module.

7. The method of claim 6, wherein the user interface configuration of the module includes two or more buttons included in the module and the at least one tag associated with the user interface configuration of the module includes at least one tag associated with each button of the two or more buttons.

8. The method of claim 7, wherein the first user interaction corresponds to a selection of a first button in the first interactive module and filtering the plurality of items based on the first interaction includes assigning items from the plurality of items having the at least one tag associated with the first button to the first group of item, and
wherein the second user interaction corresponds to a selection of a second button in the second interactive module and filtering the first group of items based on the second interaction includes assigning items from the first group of items having the at least one tag associated with the second button to the second group of items.

9. The method of claim 8, wherein presenting at least a portion of the second group of items to the user as the recommended group of items includes assigning items from the second group of items to the recommended group of items based on the priority weight associated with each item.

10. The method of claim 9, wherein the priority weights of the plurality of items are scaled based on at least one of:
(a) a manufacturer of the item;
(b) a supplier of the item;
(c) a promotion associated with the item; or
(d) the inventory status of the item.

11. A system for providing a discovery engine for filtering a plurality of items, the system comprising:
at least one memory for storing computer-executable instructions; and
at least one processor for executing the instructions stored on the memory, wherein execution of the instructions programs the at least one processor to perform operations comprising:
displaying a first interactive module of a plurality of interactive modules to a user;
receiving a first user interaction associated with the first interactive module;
filtering the plurality of items based on the first interaction to provide a first group of items;
displaying a second interactive module of the plurality of interactive modules to the user;
receiving a second user interaction associated with the second interactive module;
filtering the first group of items based on the second interaction to provide a second group of items; and
displaying a third interactive module of the plurality of interactive modules, the third interactive module being configured to present at least a portion of the second group of items to the user as a recommended group of items.

12. The system of claim 11, wherein displaying the interactive modules includes displaying the interactive modules on at least one webpage configured to enable the user to purchase one or more items from the recommended group of items.

13. The system of claim 11, wherein the operations further comprise:
receiving a data structure including data corresponding to the plurality of interactive modules and the plurality of items.

14. The system of claim 13, wherein at least a portion of the data included in the data structure is dynamically updated via an application program interface (API) from at least one webpage associated with the plurality of items.

15. The system of claim 13, wherein the data in the data structure corresponding to each item of the plurality of items includes at least one of:
(a) an image of the item;
(b) an inventory status of the item;
(c) at least one priority weight associated with the item;
(d) filter criteria associated with the item; or
(e) at least one tag associated with the item.

16. The system of claim 15, wherein the data in the data structure corresponding to each module of the plurality of interactive modules includes at least one of:
(a) a module type of the module;
(b) video content associated with the module;
(c) a user interface configuration of the module; or
(d) at least one tag associated with the user interface configuration of the module.

17. The system of claim 16, wherein the user interface configuration of the module includes two or more buttons included in the module and the at least one tag associated with the user interface configuration of the module includes at least one tag associated with each button of the two or more buttons.

18. The system of claim 17, wherein the first user interaction corresponds to a selection of a first button in the first interactive module and filtering the plurality of items based on the first interaction includes assigning items from the plurality of items having the at least one tag associated with the first button to the first group of item, and
wherein the second user interaction corresponds to a selection of a second button in the second interactive module and filtering the first group of items based on the second interaction includes assigning items from the first group of items having the at least one tag associated with the second button to the second group of items.

19. The system of claim 18, wherein presenting at least a portion of the second group of items to the user as the recommended group of items includes assigning items from the second group of items to the recommended group of items based on the priority weight associated with each item.

20. The system of claim 19, wherein the priority weights of the plurality of items are scaled based on at least one of:
(a) a manufacturer of the item;
(b) a supplier of the item;
(c) a promotion associated with the item; or
(d) the inventory status of the item.
